(19) United States
(12) Patent Application Publication
(10) Pub. No.: US 2025/0007885 A1
(43) Pub. Date: Jan. 2, 2025

(54) Tunneling with fully qualified domain name hosts

(71) Applicant: Sophos Limited, Abingdon (GB)

(72) Inventor: Nikhil Bhandari, Bangalore (IN)

(21) Appl. No.: 18/215,905

(22) Filed: Jun. 29, 2023

(51) Int. Cl. H04L 9/40; H04L 67/143

(52) U.S. Cl. CPC H04L 63/0272; H04L 63/029; H04L 67/143

(57) ABSTRACT

Systems and methods for monitoring a file establishing a Secure Sockets Layer (SSL) Virtual Private Network (VPN) tunnel route. The method includes receiving a connection request from a client associated with a fully qualified domain name (FQDN) to use a SSLVPN tunnel service; referencing a data storage for data associated with the client; constructing a client configuration file based on the data associated with the client; resolving the FQDN associated with the client to at least one internet protocol (IP) address; storing the resolved IP address in the configuration file; and communicating the configuration file to the client to instruct the client regarding how to automatically configure an SSL VPN tunnel route for the at least one resolved IP address.

### TECHNICAL FIELD

The present application relates generally to systems and methods for facilitating network communications and, more particularly but not exclusively, to systems and methods for facilitating tunnel-based network communications.

### BACKGROUND

Network communication tunnels are typically facilitated by a server instance on one end and one or more clients on the other end. Secure Sockets Layer (SSL) Virtual Private Network (VPN) tunnels are based on the Transport Layer Security (TLS) protocol and provide a secure communication channel between two endpoints on a network.

Tunnels can be configured in “full tunnel” mode or “split tunnel” mode. In full tunnel mode, all traffic from the client goes through the tunnel and reaches the destination endpoint. In split tunnel mode, only some of the traffic from the client goes through the tunnel; the remaining data is transmitted outside the tunnel.

When a client initiates a connection, the connection request is typically sent using Internet Protocol (IP) addresses. Existing SSL VPN implementations, however, do not support fully qualified domain name (FQDN) hosts in networks. Accordingly, for clients using VPN tunnels, it is not possible to tunnel traffic based on FQDN addresses.

### SUMMARY

This summary is provided to introduce a selection of concepts in a simplified form that are further described below in the Detailed Description section. This summary is not intended to identify or exclude key features or essential features of the claimed subject matter, nor is it intended to be used as an aid in determining the scope of the claimed subject matter.

The embodiments described herein support FQDN hosts with SSL VPN tunneling. In operation, a client may initiate a connection request to use an SSL VPN service. A file system may reference one or more databases for data associated with the client, and also communicate a request to an FQDN service. The FQDN service may then respond with any resolved IP addresses, which are written to the configuration file and provided to the SSL VPN service.

The SSL VPN service may then respond to the client with the configuration file. The client can then configure the routes to use the IP addresses resolved for the FQDN hosts. If there are any changes to the FQDN host, then the FQDN service may notify a configuration service. The configuration service may detect if any SSL VPN policies use the affected hosts and identify any clients that are connected to these hosts. If so, the configuration service may send a request to the SSL VPN service to disconnect these clients.

### BRIEF DESCRIPTION OF DRAWINGS

Non-limiting and non-exhaustive embodiments of the invention are described with reference to the following figures, wherein like reference numerals refer to like parts throughout the various views unless otherwise specified.

FIG. 1 illustrates a threat management system in accordance with one embodiment;

FIG. 2 illustrates a system for establishing a Secure Sockets Layer (SSL) Virtual Private Network (VPN) tunnel route in accordance with one embodiment;

FIG. 3 depicts a message sequence diagram involving components of FIG. 2 in accordance with one embodiment;

FIG. 4 presents a configuration file in accordance with one embodiment; and

FIG. 5 depicts a flowchart of a method for establishing an SSL VPN tunnel route in accordance with one embodiment.

### DETAILED DESCRIPTION

Various embodiments are described more fully below with reference to the accompanying drawings, which form a part hereof, and which show specific embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques and implementations of the present disclosure to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment.

Some portions of the description that follow are presented in terms of symbolic representations of operations on non-transient signals stored within a computer memory. These descriptions and representations are used by those skilled in the data processing arts to most effectively convey the substance of their work to others skilled in the art. Such operations typically require physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices. Portions of the present disclosure include processes and instructions that may be embodied in software, firmware or hardware, and when embodied in software, may be downloaded to reside on and be operated from different platforms used by a variety of operating systems.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMS, EEPROMs, magnetic or optical cards, application specific integrated circuits (ASICs), or any type of media suitable for storing electronic instructions, and each may be coupled to a computer system bus. Furthermore, the computers referred to in the specification may include a single processor or may be architectures employing multiple processor designs for increased computing capability.

The processes and displays presented herein are not inherently related to any particular computer or other apparatus. Various general-purpose systems may also be used with programs in accordance with the teachings herein, or it may prove convenient to construct more specialized apparatus to perform one or more method steps. The structure for a variety of these systems is discussed in the description below. In addition, any particular programming language that is sufficient for achieving the techniques and implementations of the present disclosure may be used. A variety of programming languages may be used to implement the present disclosure as discussed herein.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

An SSL VPN is a network that provides secure and remote access capability. These types of networks allow remote devices to establish a secure connection with, for example, their employer's network. Accordingly, SSL VPNs allow users to remotely access network resources on private networks from remote locations. For example, an employee working from home or at a location remote from their employer's physical headquarters may use an SSL VPN connection to securely access their employer's resources.

An SSL VPN connection provides encryption to protect transmitted communications. SSL VPN connections also provide a high level of compatibility between client platforms, remote networks, and devices thereon.

SSL VPN connections may operate in full or split tunnel modes. As discussed previously, in full tunnel modes all traffic from a client goes through an SSL VPN tunnel and arrives at an endpoint. In split tunnel mode, only some of the client's traffic goes through the tunnel. It may be undesirable for certain traffic, such as traffic unrelated to a user's employment, to travel over an SSL VPN tunnel.

The traffic that is able to go through the tunnel in split tunnel mode may depend on client policies, server policies, or otherwise how the server is configured. These policies are typically defined during the connection establishment message exchange. These policies may be defined in terms of IP addresses and IP networks. Currently, only statically configured IP addresses or networks are supported for split tunnels.

The embodiments described herein provide novel techniques for establishing SSL VPN tunnel routes for FQDNs. The embodiments described herein utilize an FQDN service, an SSL VPN service, and a configuration service. The FQDN service resolves configured FQDNs and maintains the timeouts for these resolutions. The SSL VPN service may send the resolved IP address(es) to the client during a connection establishment phase. The resolved IP addresses(es) are communicated to the client in a dynamically generated configuration file that is created in response to the client's connection request.

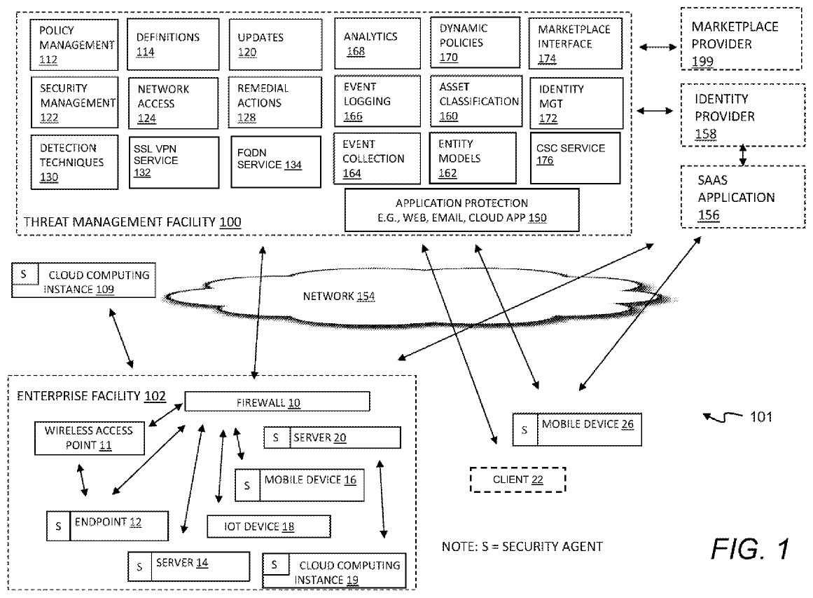

FIG. 1 illustrates a block diagram of a threat management system 101 providing protection against a plurality of threats, such as malware, viruses, spyware, cryptoware, adware, Trojans, spam, intrusion, policy abuse, improper configuration, vulnerabilities, improper access, uncontrolled access, and more. A threat management facility 100 may communicate with, coordinate, and control operation of security functionality at different control points, layers, and levels within the threat management system 101. A number of capabilities may be provided by a threat management facility 100, with an overall goal to intelligently use the breadth and depth of information that is available about the operation and activity of compute instances and networks as well as a variety of available controls. Another overall goal is to provide protection needed by an organization that is dynamic and able to adapt to changes in compute instances and new threats. In embodiments, the threat management facility 100 may provide protection from a variety of threats to a variety of compute instances in a variety of locations and network configurations.

The threat management facility 100 may execute one or more modules or facilities to analyze files that have been requested for download by a user device. For example, the threat management facility 100 may be tasked with monitoring and ensuring the security of devices on an enterprise facility 102. Upon a device on the enterprise facility 102 requesting to download a file, the threat management facility 100 or components thereof may analyze the file to determine whether the device is permitted to download the file.

As one example, users of the threat management facility 100 may define and enforce policies that control access to and use of compute instances, networks and data. Administrators may update policies such as by designating authorized users and conditions for use and access. The threat management facility 100 may update and enforce those policies at various levels of control that are available, such as by directing compute instances to control the network traffic that is allowed to traverse firewalls and wireless access points, applications and data available from servers, applications and data permitted to be accessed by endpoints, and network resources and data permitted to be run and used by endpoints. The threat management facility 100 may provide many different services, and policy management may be offered as one of the services.

Turning to a description of certain capabilities and components of the threat management system 101, the enterprise facility 102 may be or may include any networked computer-based infrastructure. For example, the enterprise facility 102 may be corporate, commercial, organizational, educational, governmental, or the like. As home networks become more complicated and include more compute instances at home and in the cloud, an enterprise facility 102 may also or instead include a personal network such as a home or a group of homes. The enterprise facility's 102 computer network may be distributed amongst a plurality of physical premises such as buildings on a campus, and located in one or in a plurality of geographical locations. The configuration of the enterprise facility as shown is by way of example, and it will be understood that there may be any number of compute instances, less or more of each type of compute instances, and other types of compute instances. As shown, the enterprise facility includes a firewall 10, a wireless access point 11, an endpoint 12, a server 14, a mobile device 16, an appliance or Internet-of-Things (IoT) device 18, a cloud computing instance 19, and a server 20. Again, the compute instances 10-20 depicted are by way of example, and there may be any number or types of compute instances 10-20 in a given enterprise facility. For example, in addition to the elements depicted in the enterprise facility 102, there may be one or more gateways, bridges, wired networks, wireless networks, virtual private networks, other compute instances, and so on.

The threat management facility 100 may include certain facilities, such as a policy management facility 112, security management facility 122, update facility 120, definitions facility 114, network access facility 124, remedial action facility 128, detection techniques facility 130, an SSL VPN service 132, an FQDN service 134, application protection 150, asset classification facility 160, entity model facility 162, event collection facility 164, event logging facility 166, analytics facility 168, dynamic policies facility 170, identity management facility 172, and marketplace interface facility 174, as well as other facilities. For example, there may be a testing facility, a threat research facility, and other facilities (not shown). It should be understood that the threat management facility 100 may be implemented in whole or in part on a number of different compute instances, with some parts of the threat management facility on different compute instances in different locations. For example, some or all of one or more of the various facilities 100, 112-174 may be provided as part of a security agent S that is included in software running on a compute instance 10-26 within the enterprise facility 102. Some or all of one or more of the facilities 100, 112-174 may be provided on the same physical hardware or logical resource as a gateway, such as a firewall 10, or wireless access point 11. Some or all of one or more of the facilities 100, 112-174 may be provided on one or more cloud servers that are operated by the enterprise or by a security service provider, such as the cloud computing instance 109.

In embodiments, a marketplace provider 199 may make available one or more additional facilities to the enterprise facility 102 via the threat management facility 100. The marketplace provider 199 may communicate with the threat management facility 100 via the marketplace interface facility 174 to provide additional functionality or capabilities to the threat management facility 100 and compute instances 10-26. As non-limiting examples, the marketplace provider 199 may be a third-party information provider, such as a physical security event provider; the marketplace provider 199 may be a system provider, such as a human resources system provider or a fraud detection system provider; the marketplace provider 199 may be a specialized analytics provider; and so on. The marketplace provider 199, with appropriate permissions and authorization, may receive and send events, observations, inferences, controls, convictions, policy violations, or other information to the threat management facility 100. For example, the marketplace provider 199 may subscribe to and receive certain events, and in response, based on the received events and other events available to the marketplace provider 199, send inferences to the marketplace interface facility 174, and in turn to the analytics facility 168, which in turn may be used by the security management facility 122.

The identity provider 158 may be any remote identity management system or the like configured to communicate with an identity management facility 172, e.g., to confirm identity of a user as well as provide or receive other information about users that may be useful to protect against threats. In general, the identity provider 158 may be any system or entity that creates, maintains, and manages identity information for principals while providing authentication services to relying party applications, e.g., within a federation or distributed network. The identity provider 158 may, for example, offer user authentication as a service, where other applications, such as web applications, outsource the user authentication step(s) to a trusted identity provider.

In embodiments, the identity provider 158 may provide user identity information, such as multi-factor authentication, to a software-as-a-service (SaaS) application. Centralized identity providers such as Microsoft Azure, may be used by an enterprise facility instead of maintaining separate identity information for each application or group of applications, and as a centralized point for integrating multifactor authentication. In embodiments, the identity management facility 172 may communicate hygiene, or security risk information, to the identity provider 158. The identity management facility 172 may determine a risk score for a user based on the events, observations, and inferences about that user and the compute instances associated with the user. If a user is perceived as risky, the identity management facility 172 may inform the identity provider 158, and the identity provider 158 may take steps to address the potential risk, such as to confirm the identity of the user, confirm that the user has approved the SaaS application access, remediate the user's system, or such other steps as may be useful.

In embodiments, threat protection provided by the threat management facility 100 may extend beyond the network boundaries of the enterprise facility 102 to include clients (or client facilities) such as a client 22 or other type of computing device outside the enterprise facility 102, a mobile device 26, a cloud computing instance 109, or any other devices, services or the like that use network connectivity not directly associated with or controlled by the enterprise facility 102, such as a mobile network, a public cloud network, or a wireless network at a hotel or coffee shop or other type of public location. While threats may come from a variety of sources, such as from network threats, physical proximity threats, secondary location threats, the compute instances 10-26 may be protected from threats even when a compute instance 10-26 is not connected to the enterprise facility 102 network, such as when the client 22 or other compute instances 26 use a network that is outside of the enterprise facility 102 and separated from the enterprise facility 102, e.g., by a gateway, a public network, and so forth.

In some implementations, compute instances 10-26 may communicate with cloud applications, such as a SaaS application 156. The SaaS application 156 may be an application that is used by but not operated by the enterprise facility 102. Examples of commercially available SaaS applications 156 include Salesforce, Amazon Web Services (AWS) applications, Google Apps applications, Microsoft Office 365 applications and so on. A given SaaS application 156 may communicate with an identity provider 158 to verify user identity consistent with the requirements of the enterprise facility 102. The compute instances 10-26 may communicate with an unprotected server (not shown) such as a web site or a third-party application through an internetwork 154 such as the Internet or any other public network, private network or combination thereof.

In embodiments, aspects of the threat management facility 100 may be provided as a stand-alone solution. In other embodiments, aspects of the threat management facility 100 may be integrated into a third-party product. An application programming interface (e.g., a source code interface) may be provided such that aspects of the threat management facility 100 may be integrated into or used by or with other applications. For instance, the threat management facility 100 may be stand-alone in that it provides direct threat protection to an enterprise or computer resource, where protection is subscribed to the facility 100. Alternatively, the threat management facility 100 may offer protection indirectly, through a third-party product, where an enterprise may subscribe to services through the third-party product, and threat protection to the enterprise may be provided by the threat management facility 100 through the third-party product.

The security management facility 122 may provide protection from a variety of threats by providing, as non-limiting examples, endpoint security and control, email security and control, web security and control, reputation-based filtering, machine learning classification, control of unauthorized users, control of guest and non-compliant computers, and more.

The security management facility 122 may provide malicious code protection to a compute instance. The security management facility 122 may include functionality to scan applications, files, and data for malicious code, remove or quarantine applications and files, prevent certain actions, perform remedial actions, as well as other security measures. Scanning may use any of a variety of techniques, including without limitation signatures, identities, classifiers, and other suitable scanning techniques. In embodiments, the scanning may include scanning some or all files on a periodic basis, scanning an application when the application is executed, scanning data transmitted to or from a device, scanning in response to predetermined actions or combinations of actions, and so forth. The scanning of applications, files, and data may be performed to detect known or unknown malicious code or unwanted applications. Aspects of the malicious code protection may be provided, for example, in a security agent of an endpoint 12, in a wireless access point 11 or firewall 10, as part of application protection 150 provided by the cloud, and so on.

In an embodiment, the security management facility 122 may provide for email security and control, for example to target spam, viruses, spyware and phishing, to control email content, and the like. Email security and control may protect against inbound and outbound threats, protect email infrastructure, prevent data leakage, provide spam filtering, and more. Aspects of the email security and control may be provided, for example, in the security agent of an endpoint 12, in a wireless access point 11 or firewall 10, as part of application protection 150 provided by the cloud, and so on.

In an embodiment, security management facility 122 may provide for web security and control, for example, to detect or block viruses, spyware, malware, or unwanted applications; help control web browsing; and the like, which may provide comprehensive web access control to enable safe and productive web browsing. Web security and control may provide Internet use policies, reporting on suspect compute instances, security and content filtering, active monitoring of network traffic, Uniform Resource Identifier (URI) filtering, and the like. Aspects of the web security and control may be provided, for example, in the security agent of an endpoint 12, in a wireless access point 11 or firewall 10, as part of application protection 150 provided by the cloud, and so on.

In an embodiment, the security management facility 122 may provide for network access control, which generally controls access to and use of network connections. Network control may stop unauthorized, guest, or non-compliant systems from accessing networks, and may control network traffic that is not otherwise controlled at the client level. In addition, network access control may control access to virtual private networks (VPN), where VPNs may, for example, include communications networks tunneled through other networks and establishing logical connections acting as virtual networks. In embodiments, a VPN may be treated in the same manner as a physical network. Aspects of network access control may be provided, for example, in the security agent of an endpoint 12, in a wireless access point 11 or firewall 10, as part of application protection 150 provided by the cloud, e.g., from the threat management facility 100 or other network resource(s).

In an embodiment, the security management facility 122 may provide for host intrusion prevention through behavioral monitoring and/or runtime monitoring, which may guard against unknown threats by analyzing application behavior before or as an application runs. This may include monitoring code behavior, application programming interface calls made to libraries or to the operating system, or otherwise monitoring application activities. Monitored activities may include, for example, reading and writing to memory, reading and writing to disk, network communication, process interaction, and so on. Behavior and runtime monitoring may intervene if code is deemed to be acting in a manner that is suspicious or malicious. Aspects of behavior and runtime monitoring may be provided, for example, in the security agent of an endpoint 12, in a wireless access point 11 or firewall 10, as part of application protection 150 provided by the cloud, and so on.

In an embodiment, the security management facility 122 may provide for reputation filtering, which may target or identify sources of known malware. For instance, reputation filtering may include lists of URIs of known sources of malware or known suspicious IP addresses, code authors, code signers, or domains, that when detected may invoke an action by the threat management facility 100. Based on reputation, potential threat sources may be blocked, quarantined, restricted, monitored, or some combination of these, before an exchange of data is made. Aspects of reputation filtering may be provided, for example, in the security agent of an endpoint 12, in a wireless access point 11 or firewall 10, as part of application protection 150 provided by the cloud, and so on. In embodiments, some reputation information may be stored on a compute instance 10-26, and other reputation data available through cloud lookups to an application protection lookup database, such as may be provided by application protection 150.

In embodiments, information may be sent from the enterprise facility 102 to a third party, such as a security vendor, or the like, which may lead to improved performance of the threat management facility 100. In general, feedback may be useful for any aspect of threat detection. For example, the types, times, and number of virus interactions that an enterprise facility 102 experiences may provide useful information for the preventions of future virus threats. Feedback may also be associated with behaviors of individuals within the enterprise, such as being associated with most common violations of policy, network access, unauthorized application loading, unauthorized external device use, and the like. In embodiments, feedback may enable the evaluation or profiling of client actions that are violations of policy that may provide a predictive model for the improvement of enterprise policies.

An update facility 120 may provide control over when updates are performed. The updates may be automatically transmitted, manually transmitted, or some combination of these. Updates may include software, definitions, reputations or other code or data that may be useful to the various facilities. For example, the update facility 120 may manage receiving updates from a provider, distribution of updates to enterprise facility 102 networks and compute instances, or the like. In embodiments, updates may be provided to the enterprise facility's 102 network, where one or more compute instances on the enterprise facility's 102 network may distribute updates to other compute instances.

The threat management facility 100 may include a policy management facility 112 that manages rules or policies for the enterprise facility 102. Examples of rules include access permissions associated with networks, applications, compute instances, users, content, data, and the like. The policy management facility 112 may use a database, a text file, other data store, or a combination to store policies. In an embodiment, a policy database may include a block list, a black list, an allowed list, a white list, and more. As a few non-limiting examples, policies may include a list of enterprise facility 102 external network locations/applications that may or may not be accessed by compute instances, a list of types/classifications of network locations or applications that may or may not be accessed by compute instances, and contextual rules to evaluate whether the lists apply. For example, there may be a rule that does not permit access to sporting websites. When a website is requested by the client facility, a security management facility 122 may access the rules within a policy facility to determine if the requested access is related to a sporting website.

The policy management facility 112 may include access rules and policies that are distributed to maintain control of access by the compute instances 10-26 to network resources. These policies may be defined for an enterprise facility, application type, subset of application capabilities, organization hierarchy, compute instance type, user type, network location, time of day, connection type, or any other suitable definition. Policies may be maintained through the threat management facility 100, in association with a third party, or the like. For example, a policy may restrict instant messaging (IM) activity by limiting such activity to support personnel when communicating with customers. More generally, this may allow communication for departments as necessary or helpful for department functions, but may otherwise preserve network bandwidth for other activities by restricting the use of IM to personnel that need access for a specific purpose. In an embodiment, the policy management facility 112 may be a stand-alone application, may be part of the network server facility 142, may be part of the enterprise facility 102 network, may be part of the client facility, or any suitable combination of these.

The policy management facility 112 may include dynamic policies that use contextual or other information to make security decisions. As described herein, the dynamic policies facility 170 may generate policies dynamically based on observations and inferences made by the analytics facility. The dynamic policies generated by the dynamic policy facility 170 may be provided by the policy management facility 112 to the security management facility 122 for enforcement.

In embodiments, the threat management facility 100 may provide configuration management as an aspect of the policy management facility 112, the security management facility 122, or some combination. Configuration management may define acceptable or required configurations for the compute instances 10-26, applications, operating systems, hardware, or other assets, and manage changes to these configurations. Assessment of a configuration may be made against standard configuration policies, detection of configuration changes, remediation of improper configurations, application of new configurations, and so on. An enterprise facility may have a set of standard configuration rules and policies for particular compute instances which may represent a desired state of the compute instance. For example, on a given compute instance 12, 14, 18, a version of a client firewall may be required to be running and installed. If the required version is installed but in a disabled state, the policy violation may prevent access to data or network resources. A remediation may be to enable the firewall. In another example, a configuration policy may disallow the use of Universal Serial Bus (USB) disks, and the policy management facility 112 may require a configuration that turns off USB drive access via a registry key of a compute instance. Aspects of configuration management may be provided, for example, in the security agent of an endpoint 12, in a wireless access point 11 or firewall 10, as part of application protection 150 provided by the cloud, or any combination of these.

In embodiments, the threat management facility 100 may also provide for the isolation or removal of certain applications that are not desired or may interfere with the operation of a compute instance 10-26 or the threat management facility 100, even if such application is not malware per se. The operation of such products may be considered a configuration violation. The removal of such products may be initiated automatically whenever such products are detected, or access.

The policy management facility 112 may also require update management (e.g., as provided by the update facility 120). Update management for the security management facility 122 and policy management facility 112 may be provided directly by the threat management facility 100, or, for example, by a hosted system. In embodiments, the threat management facility 100 may also provide for patch management, where a patch may be an update to an operating system, an application, a system tool, or the like, where one of the reasons for the patch is to reduce vulnerability to threats.

In embodiments, the security management facility 122 and policy management facility 112 may push information to the enterprise facility 102 network and/or the compute instances 10-26, the enterprise facility 102 network and/or compute instances 10-26 may pull information from the security management facility 122 and policy management facility 112, or there may be a combination of pushing and pulling of information. For example, the enterprise facility 102 network and/or compute instances 10-26 may pull update information from the security management facility 122 and policy management facility 112 via the update facility 120, an update request may be based on a time period, by a certain time, by a date, on demand, or the like. In another example, the security management facility 122 and policy management facility 112 may push the information to the enterprise facility's 102 network and/or compute instances 10-26 by providing notification that there are updates available for download and/or transmitting the information. In an embodiment, the policy management facility 112 and the security management facility 122 may work in concert with the update facility 120 to provide information to the enterprise facility's 102 network and/or compute instances 10-26. In various embodiments, policy updates, security updates and other updates may be provided by the same or different modules, which may be the same or separate from a security agent running on one of the compute instances 10-26.

As threats are identified and characterized, the definition facility 114 of the threat management facility 100 may manage definitions used to detect and remediate threats. For example, identity definitions may be used for scanning files, applications, data streams, etc. for the determination of malicious code. Identity definitions may include instructions and data that may be parsed and acted upon for recognizing features of known or potentially malicious code. Definitions also may include, for example, code or data to be used in a classifier, such as a neural network or other classifier that may be trained using machine learning. Updated code or data may be used by the classifier to classify threats. In embodiments, the threat management facility 100 and the compute instances 10-26 may be provided with new definitions periodically to include most recent threats. Updating of definitions may be managed by the update facility 120, and may be performed upon request from one of the compute instances 10-26, upon a push, or some combination. Updates may be performed upon a time period, on demand from a device 10-26, upon determination of an important new definition or a number of definitions, and so on.

A threat research facility (not shown) may provide a continuously ongoing effort to maintain the threat protection capabilities of the threat management facility 100 in light of continuous generation of new or evolved forms of malware. Threat research may be provided by researchers and analysts working on known threats, in the form of policies, definitions, remedial actions, and so on.

The security management facility 122 may scan an outgoing file and verify that the outgoing file is permitted to be transmitted according to policies. By checking outgoing files, the security management facility 122 may be able discover threats that were not detected on one of the compute instances 10-26, or policy violation, such transmittal of information that should not be communicated unencrypted.

The threat management facility 100 may control access to the enterprise facility 102 networks. A network access facility 124 may restrict access to certain applications, networks, files, printers, servers, databases, and so on. In addition, the network access facility 124 may restrict user access under certain conditions, such as the user's location, usage history, need to know, job position, connection type, time of day, method of authentication, client-system configuration, or the like. Network access policies may be provided by the policy management facility 112, and may be developed by the enterprise facility 102, or pre-packaged by a supplier. Network access facility 124 may determine if a given compute instance 10-22 should be granted access to a requested network location, e.g., inside or outside of the enterprise facility 102. Network access facility 124 may determine if a client 22 or compute instance 26 such as a device outside the enterprise facility 102 may access the enterprise facility 102. For example, in some cases, the policies may require that when certain policy violations are detected, certain network access is denied. The network access facility 124 may communicate remedial actions that are necessary or helpful to bring a device back into compliance with policy as described below with respect to the remedial action facility 128. Aspects of the network access facility 124 may be provided, for example, in the security agent of the endpoint 12, in a wireless access point 11, in a firewall 10, as part of application protection 150 provided by the cloud, and so on.

In an embodiment, the network access facility 124 may have access to policies that include one or more of a block list, a black list, an allowed list, a white list, an unacceptable network site database, an acceptable network site database, a network site reputation database, or the like of network access locations that may or may not be accessed by the client facility. Additionally, the network access facility 124 may use rule evaluation to parse network access requests and apply policies. The network access facility 124 may have a generic set of policies for all compute instances, such as denying access to certain types of websites, controlling instant messenger accesses, or the like. Rule evaluation may include regular expression rule evaluation, or other rule evaluation method(s) for interpreting the network access request and comparing the interpretation to established rules for network access. Classifiers may be used, such as neural network classifiers or other classifiers that may be trained by machine learning.

The threat management facility 100 may include an asset classification facility 160. The asset classification facility will discover the assets present in the enterprise facility 102. A compute instance such as any of the compute instances 10-26 described herein may be characterized as a stack of assets. The one level asset is an item of physical hardware. The compute instance may be, or may be implemented on physical hardware, and may have or may not have a hypervisor, or may be an asset managed by a hypervisor. The compute instance may have an operating system (e.g., Windows, macOS, OS X, Linux, Android, IOS). The compute instance may have one or more layers of containers. The compute instance may have one or more applications, which may be native applications, e.g., for a physical asset or virtual machine, or running in containers within a computing environment on a physical asset or virtual machine, and those applications may link libraries or other code or the like, e.g., for a user interface, cryptography, communications, device drivers, mathematical or analytical functions and so forth. The stack may also interact with data. The stack may also or instead interact with users, and so users may be considered assets.

The threat management facility 100 may include the entity model facility 162. The entity models may be used, for example, to determine the events that are generated by assets. For example, some operating systems may provide useful information for detecting or identifying events. For examples, operating systems may provide process and usage information that accessed through an application programming interface (API). As another example, it may be possible to instrument certain containers to monitor the activity of applications running on them. As another example, entity models for users may define roles, groups, permitted activities and other attributes.

The event collection facility 164 may be used to collect events from any of a wide variety of sensors that may provide relevant events from an asset, such as sensors on any of the compute instances 10-26, the application protection 150, a cloud computing instance 109 and so on. The events that may be collected may be determined by the entity models. There may be a variety of events collected. Events may include, for example, events generated by the enterprise facility 102 or the compute instances 10-26, such as by monitoring streaming data through a gateway such as firewall 10 and wireless access point 11, monitoring activity of compute instances, monitoring stored files/data on the compute instances 10-26 such as desktop computers, laptop computers, other mobile computing devices, and cloud computing instances 19, 109. Events may range in granularity. One example of an event is the communication of a specific packet over the network. Another example of an event may be identification of an application that is communicating over a network.

The event logging facility 166 may be used to store events collected by the event collection facility 164. The event logging facility 166 may store collected events so they may be accessed and analyzed by the analytics facility 168. Some events may be collected locally, and some events may be communicated to an event store in a central location or cloud facility. Events may be logged in any suitable format.

Events collected by the event logging facility 166 may be used by the analytics facility 168 to make inferences and observations about the events. These observations and inferences may be used as part of policies enforced by the security management facility Observations or inferences about events may also be logged by the event logging facility 166.

When a threat or other policy violation is detected by the security management facility 122, the remedial action facility 128 may remediate the threat. Remedial action may take a variety of forms, non-limiting examples including collecting additional data about the threat, terminating or modifying an ongoing process or interaction, sending a warning to a user or administrator, downloading a data file with commands, definitions, instructions, or the like to remediate the threat, requesting additional information from the requesting device, such as the application that initiated the activity of interest, executing a program or application to remediate against a threat or violation, increasing telemetry or recording interactions for subsequent evaluation, (continuing to) block requests to a particular network location or locations, scanning a requesting application or device, quarantine of a requesting application or the device, isolation of the requesting application or the device, deployment of a sandbox, blocking access to resources, e.g., a USB port, or other remedial actions. More generally, the remedial action facility 128 may take any steps or deploy any measures suitable for addressing a detection of a threat, potential threat, policy violation or other event, code or activity that might compromise security of a computing instance 10-26 or the enterprise facility 102 as identified by one or more of the facilities such as the policy management facility 112, security management facility 122, update facility 120, definitions facility 114, network access facility 124, detection techniques facility 130, an SSL VPN service 132, an FQDN service 134, application protection 150, asset classification facility 160, entity model facility 162, event collection facility 164, event logging facility 166, analytics facility 168, dynamic policies facility 170, identity management facility 172, marketplace interface facility 174, and a configuration (CSC) service 176 as well as other facilities.

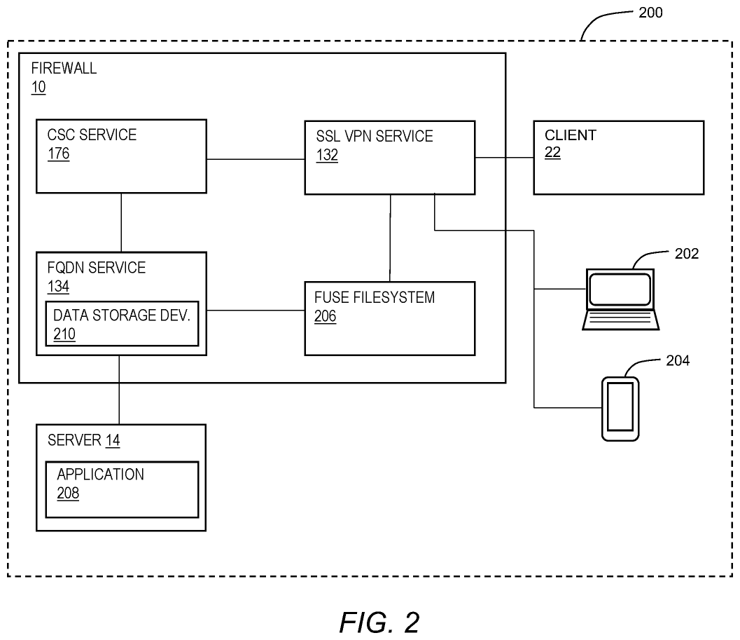

FIG. 2 illustrates a system 200 for establishing an SSL VPN tunnel route to an FQDN host in accordance with one embodiment. In one embodiment, the system 200 includes the firewall 10 of FIG. 1 in communication with one or more devices (e.g., a client 22, a personal computer (PC) 202, a mobile device 204, etc.). The firewall 10 may implement one or more services and/or file systems, including but not limited to the SSL VPN service 132, the FQDN service 134, a file system in user space (FUSE filesystem) 206, and the configuration (CSC) service 176. These services and filesystems may be at different locations and may be instantiated by the firewall 10 or by some other network resource or at another location.

The client 22 may refer to a client machine executing a user interface and accessible by a user. The user may be an employee of a corporate entity, for example, and may want to use a local application executing by the client 22 to access a remote application 208 executable on a server 14 that is at a location remote from the client 22. In this case, the user may be working at a location remote from their employer's physical headquarters.

The client machine may be any appropriate hardware device that allows the user to access the desired remote application 208. The client machine may be, for example, a mobile phone, tablet, PC, laptop, smartwatch, or the like. Any type of client machine may be used, whether available now or invented hereafter, as long as the features of the embodiments herein may be accomplished. For example, the PC 202 and a mobile device 204 may also access the remote application 208 in accordance with the embodiments herein.

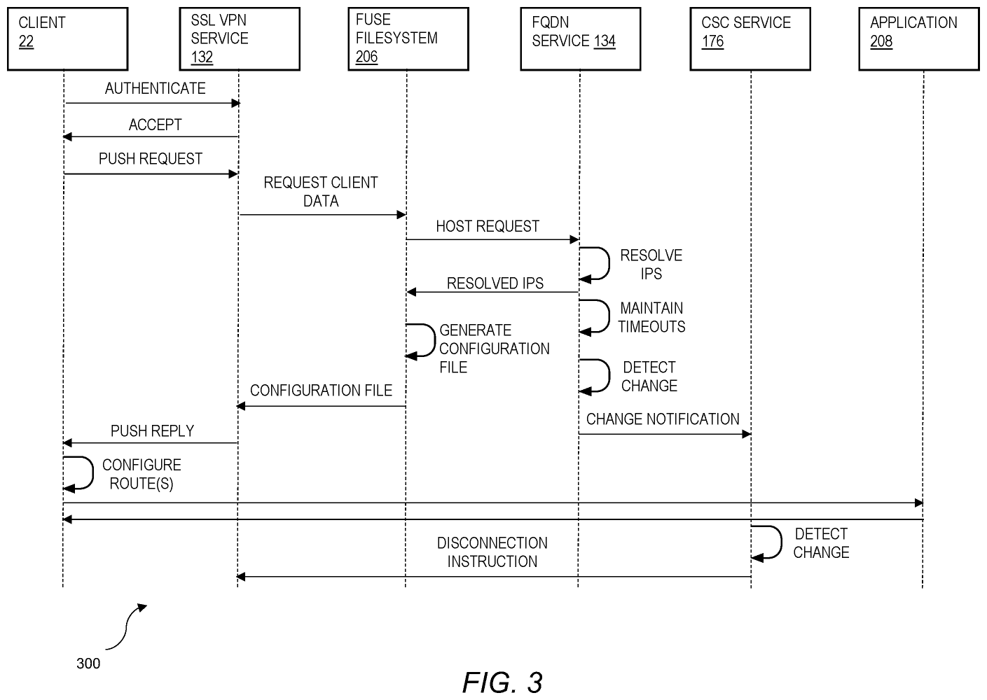

FIG. 3 depicts a message sequence diagram 300 involving components of FIG. 2 in accordance with one embodiment. To initiate a connection request, the user of the client 22 may first provide any required credentials. For example, the user may need to authenticate with the system 200 by providing, e.g., a username, password, two-factor authentication information, a hardware-based personal identification number (PIN), etc. The client 22 may be configured to execute any appropriate VPN client software.

Once the SSL VPN service 132 accepts the authentication credentials and authenticates the client 22, the client 22 may send a PUSH REQUEST to the SSL VPN service 132. The PUSH REQUEST may include data regarding, for example and without limitation, any protocol(s) followed by the client 22, tunnel parameters, what network(s) are allowed in the tunnel, etc. The PUSH REQUEST may also include requests for any information relevant in establishing a tunnel connection.

The SSL VPN service 132 may eventually respond with a PUSH REPLY. However, the SSL VPN service 132 may first need to obtain a client-specific configuration file. Accordingly, the SSL VPN service 132 may, after receiving the PUSH REQUEST from the client 22, communicate a request to the FUSE filesystem 206.

The FUSE filesystem 206 may include one or more data devices storing data associated with the client 22. The FUSE filesystem 206 may use the data associated with the client 22 to dynamically generate at least a portion of a configuration file. For example, the FUSE filesystem 206 may store data regarding addresses associated with the client 22 and other environment variables associated with the client 22. Accordingly, when there is a request to read the file, a function (e.g., an opcode function) is called to generate the output for the read request. The function will look in the FUSE filesystem 206 to generate the configuration file.

As part of the configuration file generation, the FUSE filesystem 206 may also initiate a request to the FQDN service 134 to resolve any hosts that are configured for the client 22. For example, the request by the FUSE filesystem 206 may execute in an OpenVPN plugin process, which runs as a single threaded, separate process. This is performed in a separate process that is spawned when the OpenVPN plugin is called. OpenVPN provides plugins or functions that it calls at certain stages in the tunnel establishment process. These stages may include during authentication, at connection success, at disconnection, etc. This ensures that the main processing thread is not blocked.

The FQDN service 134 may resolve configured FQDNs, and also maintain the timeouts for these resolutions. The FQDN service 134 may then respond to the FUSE filesystem 206 with the resolved IP addresses.

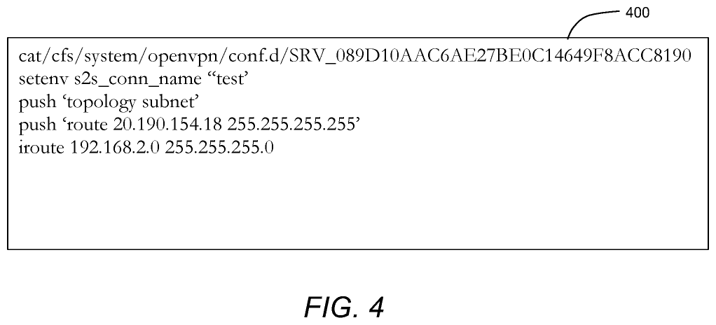

The FUSE filesystem 206 may write the resolved IP addresses to the configuration file. FIG. 4 presents data associated with or otherwise included in a configuration file 400 in accordance with one embodiment. As seen in FIG. 4, data of the configuration file 400 may include an IP address sent to the FQDN service 134, and an internal route (“iroute”) that specifies an internal route directive. The configuration file 400 may also include any other parameters relevant for establishing and maintaining a tunnel connection, such as Domain Name Server (DNS) server configuration parameters.

The FUSE filesystem 206 may then provide the configuration file 400 to the SSL VPN service 132. The SSL VPN service 132 may then provide the configuration file in a PUSH REPLY to the client 22. The client 22 may then configure the tunnel routes for the IP addresses resolved for the FQDN hosts. For example, the client 22 may read the configuration file 400 for tunnel routing information, and use the information from the configuration file 400 to establish one or more tunnel routes. For example, the client 22 may configure a domain name server (DNS) that resolves the FQDN to the same IP address. In some embodiments, the configuration file may include an option or instruction to autonomously select the DNS. The FQDN hosts may include a public domain, a private domain, a wildcard value, etc.

The client 22 then has access to any resources protected by the established tunnel, such as the application 208. For example, if a user is working from home or otherwise at a location remote from their employer's physical office, the user can access their employer's network and resources thereon.

The FQDN service 134 may continuously monitor the FQDNs for any changes in the FQDN host IP addresses. For example, each FQDN may be associated with a time-to-live (TTL) value, upon expiration of which the FQDN expires. In one embodiment, the FQDN service 134 may monitor one or more FQDNs by executing a clock or timer program for each FQDN, wherein the program tracks the time until the FQDN expires. As seen in FIG. 2, the FQDN service 134 may include or otherwise execute one or more data storage devices 210 storing data regarding the FQDNs, such as their TTL values. Accordingly, the FQDN service, when resolving the IP address, may also obtain the TTL value(s) and maintain timer(s) for each such resolution. When the timeout occurs, the FQDN service 134 may re-resolve the FQDN and notify any interested services.

In one embodiment, the FQDN service 134 may ping each FQDN for data associated therewith. The FQDN service 134 may ping the FQDN at certain temporal intervals (e.g., hourly, daily, etc.). As seen in FIG. 3, the FQDN service 134 may notify the configuration service 176 of any changes in FQDN status, such as if an FQDN expires.

Based upon a detected change with an FQDN host, the configuration service 176 may determine if any SSL VPN policies are using the relevant hosts and identify any clients that are using these hosts. If a client 22 is using one of these FQDN hosts, the configuration service 176 will communicate to the SSL VPN service 132 to disconnect the client 22.

To determine which clients are using affected hosts, the embodiments herein may include or otherwise rely on previously-created policies that specify what FQDN hosts and IP addresses are protected by the SSL VPN policies, and also which users are attached to those policies. This data may be stored in the FUSE filesystem 206 or in another location, so that if an FQDN host's TTL expires, the FQDN service 134 may determine which policy is using the host and which users are attached to the policy.

The SSL VPN service 132 may then communicate to the client 22 a disconnection request (i.e., to instruct the client 22 to terminate the tunnel connection). To establish a subsequent connection, the client 22 may communicate another connection request to the SSL VPN service 132, and the above process may be repeated.

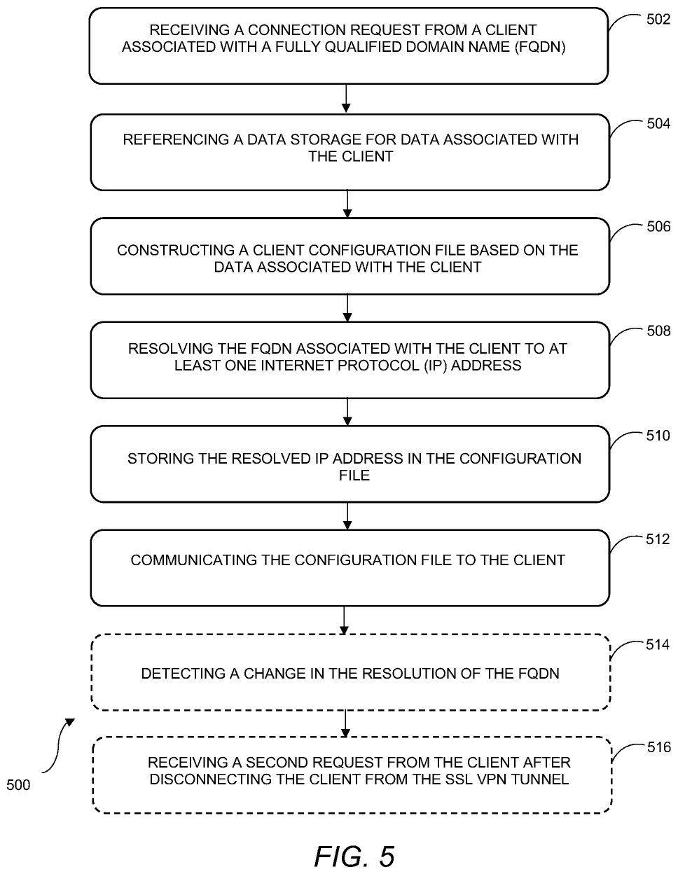

FIG. 5 depicts a flowchart of a method 500 for establishing an SSL VPN tunnel route in accordance with one embodiment. The components of the threat management facility 100 of firewall 10 may perform one or more of the steps of method 500.

Step 502 involves receiving a connection request from a client 22 associated with a fully qualified domain name (FQDN) to use a SSLVPN tunnel service 132. An SSL VPN service 132 may receive the request from the client 22, which may be operated by an employee of a corporate entity and working from a remote location, for example.

Step 504 involves referencing a data storage device such as the FUSE filesystem 206 for data associated with the client 22. To service the connection request, the embodiments herein may need to first reference a data storage device to obtain data associated with the client 22.

Step 506 involves constructing a client configuration file 400 based on the data associated with the client 22. The configuration file 400 may specify client-specific parameters and routes for the IP addresses accessible through the tunnel. The SSL VPN service 132 may perform this step using data associated with the client 22 obtained from the FUSE filesystem 206.

Step 508 involves resolving the FQDN associated with the client 22 to at least one internet protocol (IP) address(es). Step 508 may involve the FUSE filesystem 206 communicating a request to the FQDN service 134 to resolve the FQDN. Step 510 involves storing the resolved IP address in the configuration file 300. Specifically, the resolved IP address(es) may be communicated from an FQDN service 134 to the FUSE filesystem 206, where they may be accessed to populate the configuration file 400.

Step 512 involves communicating the configuration file 400 to the client 22. The client 22 may then leverage the data in the configuration file 400 to automatically configure the tunnel routes for the IP addresses resolved for the FQDN host.

Step 514 involves detecting a change in the resolution of the FQDN. For example, the FQDN may have a TTL value that has expired. In this case, the FQDN service 134 may notify the configuration service 176 of the detected change in the FQDN resolution. Step 414 may further involve disconnecting the client 22 associated with the FQDN from the SSL VPN service 132. The first step in the detection process may be the timeout for an FQDN in the FQDN service 134. Once this timeout is detected for an FQDN, it may be mapped to a host object (as communication between services is in terms of objects), and a notification is sent to the configuration service 176 that the FQDN object's resolution has expired.

The configuration service 176 may then determine which policies use this host by referencing one or more data records (e.g., records associated with the SSL VPN service 132), and determine which users are using the policy and are currently connected. For example, if the FQDN “Sophos.com” TTL expires, and an SSLVPN policy named “Sophos” has been configured to use this FQDN as a protected host, the configuration service 176 may discover the policy and the user(s) associated with the policy. The configuration service 176 can then send a disconnect request using the management interface of OpenVPN.

Step 516 involves receiving a second request from the client after disconnecting the client from the SSL VPN service 132, and using at least one parameter from the configuration file 400 to re-establish a SSL VPN tunnel service connection with the client 22. For example, the parameters of the configuration file may be or otherwise include commands that are sent to a server (e.g., an OpenVPN server) to perform certain actions. These parameters may be configured by an administrator while creating policy, for example. Accordingly, to establish a subsequent connection, the client 22 may communicate another connection request to the SSL VPN service 132, and the steps of method 500 may be repeated.

The described embodiments achieve several technical advantages in the field of network communications. First, the embodiments described herein can establish tunnel routes between network endpoints based on FQDNs. Accordingly, the embodiments herein enable SSL VPN tunnels to support dynamic IP addresses using FQDNs. This is opposed to existing techniques for establishing communications, which require static IP addresses.

Second, any changes in the IP addresses for FQDNs can be handled seamlessly and without administrator intervention. For example, the configuration service 176 autonomously issues a disconnection request to the SSL VPN service 132 based on the FQDN service detecting a change in an FQDN.

In one aspect, embodiments relate to a method for establishing a Secure Sockets Layer (SSL) Virtual Private Network (VPN) tunnel route. The method includes receiving a connection request from a client associated with a fully qualified domain name (FQDN) to use a SSLVPN tunnel service; referencing a data storage for data associated with the client; constructing a client configuration file based on the data associated with the client; resolving the FQDN associated with the client to at least one internet protocol (IP) address; storing the resolved IP address in the configuration file; and communicating the configuration file to the client to instruct the client regarding how to automatically configure an SSL VPN tunnel route for the at least one resolved IP address.

In some embodiments, the method further includes detecting a change in the resolution of the FQDN, notifying a configuration service of the detected change in the FQDN resolution, and disconnecting the client associated with the FQDN from the SSL VPN tunnel service. In some embodiments, the method further includes receiving a second request from the client after disconnecting the client from the SSL VPN tunnel service, and using at least one parameter from the configuration file to re-establish an SSL VPN tunnel service connection with the client.

In some embodiments, the method further includes requesting an FQDN service to resolve the FQDN to the at least one IP address using a single threaded process that is separate from a main processing thread.

In some embodiments, the configuration file includes a plurality of resolved IP addresses so that the client can configure an SSL VPN tunnel route for each of the at least one resolved IP addresses.

In some embodiments, the FQDN has a time-to-live value, and the method further includes re-establishing a connection with the client using the client configuration file based on expiration of the time-to-live value.

In some embodiments, the FQDN is a public domain, a private domain, or a wildcard value.

In some embodiments, a file system in user space generates the configuration file dynamically in response to receiving the request from the client.

In some embodiments, the request includes at least one of a protocol used by the client and network allowed in the SSL VPN tunnel.

According to another aspect, embodiments relate to a system for establishing a Secure Sockets layer (SSL) Virtual Private Network (VPN). The system includes an SSL VPN service for at least receiving a connection request from a client associated with a fully qualified domain name (FQDN) to use a SSL VPN tunnel service, wherein the SSL VPN tunnel service is further configured to request from a file system a configuration file specific to the client; and a fully qualified domain name (FQDN) service configured to resolve the FQDN associated with the client to at least one internet protocol (IP) address, wherein the resolved IP address is stored in the configuration file, wherein the SSL VPN service is further configured to communicate the configuration file to the client to instruct the client regarding how to configure an SSL VPN tunnel route for the at least one resolved IP address.

In some embodiments, the system further includes a configuration module to detect a change in the resolution of the FQDN and disconnect the client associated with the FQDN from the SSL VPN tunnel service. In some embodiments, the SSL VPN service is further configured to receive a second request from the client after the configuration module disconnects the client from the SSL VPN tunnel service, and use at least one parameter from the configuration file to re-establish a SSL VPN tunnel service connection with the client.

In some embodiments, the FQDN module resolves the FQDN to the at least one IP address using a single threaded process that is separate from a main processing thread.

In some embodiments, the configuration file includes a plurality of resolved IP addresses so that the client can configure an SSL VPN tunnel route for each of the at least one resolved IP addresses.

In some embodiments, each FQDN has a time-to-live value, and the method further includes re-establishing a connection with the client using the client configuration file upon expiration of the time-to-live value.

In some embodiments, the FQDN is a public domain, a private domain, or a wildcard value.

In some embodiments, the system includes a file system in user space to generate the configuration file dynamically in response to receiving the request from the client.

In some embodiments, the request includes at least one of a protocol used by the client and network allowed in the SSL VPN tunnel.

According to yet another aspect, embodiments relate to a computer program product for establishing a Secure Sockets Layer (SSL) Virtual Private Network (VPN) tunnel route, the computer program product comprising computer executable code embodied in one or more non-transitory computer readable media that, when executing on one or more processors, performs the steps of: receiving a connection request from a client associated with a fully qualified domain name (FQDN) to use a SSL VPN tunnel service; referencing a data storage for data associated with the client; constructing a client configuration file based on the data associated with the client; resolving the FQDN associated with the client to at least one internet protocol (IP) address; storing the resolved IP address in the configuration file; and communicating the configuration file to the client to instruct the client regarding how to configure an SSL VPN tunnel route for the at least one resolved IP address.

In some embodiments, the computer program product further comprises computer executable code that, when executing on one or more processors, performs the steps of detecting a change in the resolution of the FQDN, notifying a configuration service of the detected change in the FQDN resolution, and disconnecting the client associated with the FQDN from the SSL VPN service.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Embodiments of the present disclosure, for example, are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, or alternatively, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a relevant system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of the relevant system.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of various implementations or techniques of the present disclosure. Also, a number of steps may be undertaken before, during, or after the above elements are considered.

Having been provided with the description and illustration of the present application, one skilled in the art may envision variations, modifications, and alternate embodiments falling within the general inventive concept discussed in this application that do not depart from the scope of the following claims.

What is claimed is:

1. A method for establishing a Secure Sockets Layer (SSL) Virtual Private Network (VPN) tunnel route, the method comprising:
receiving a connection request from a client associated with a fully qualified domain name (FQDN) to use a SSLVPN tunnel service;
referencing a data storage for data associated with the client;
constructing a client configuration file based on the data associated with the client;
resolving the FQDN associated with the client to at least one internet protocol (IP) address;
storing the resolved IP address in the configuration file; and
communicating the configuration file to the client to instruct the client regarding how to automatically configure an SSL VPN tunnel route for the at least one resolved IP address.

2. The method of claim 1 further comprising:
detecting a change in the resolution of the FQDN;
notifying a configuration service of the detected change in the FQDN resolution; and
disconnecting the client associated with the FQDN from the SSL VPN tunnel service.

3. The method of claim 2 further comprising receiving a second request from the client after disconnecting the client from the SSL VPN tunnel service, and using at least one parameter from the configuration file to re-establish an SSL VPN tunnel service connection with the client.

4. The method of claim 1 further comprising requesting an FQDN service to resolve the FQDN to the at least one IP address using a single threaded process that is separate from a main processing thread.

5. The method of claim 1 wherein the configuration file includes a plurality of resolved IP addresses so that the client can configure an SSL VPN tunnel route for each of the at least one resolved IP addresses.

6. The method of claim 1 wherein the FQDN has a time-to-live value, and the method further includes re-establishing a connection with the client using the client configuration file based on expiration of the time-to-live value.

7. The method of claim 1 wherein the FQDN is a public domain, a private domain, or a wildcard value.

8. The method of claim 1 wherein a file system in user space generates the configuration file dynamically in response to receiving the request from the client.

9. The method of claim 1 wherein the request includes at least one of a protocol used by the client and network allowed in the SSL VPN tunnel.

10. A system for establishing a Secure Sockets layer (SSL) Virtual Private Network (VPN), the system comprising:
an SSL VPN service for at least receiving a connection request from a client associated with a fully qualified domain name (FQDN) to use a SSL VPN tunnel service, wherein the SSL VPN tunnel service is further configured to request from a file system a configuration file specific to the client; and
a fully qualified domain name (FQDN) service configured to resolve the FQDN associated with the client to at least one internet protocol (IP) address, wherein the resolved IP address is stored in the configuration file;
wherein the SSL VPN service is further configured to communicate the configuration file to the client to instruct the client regarding how to configure an SSL VPN tunnel route for the at least one resolved IP address.

11. The system of claim 10 further comprising a configuration module to:
detect a change in the resolution of the FQDN; and
disconnect the client associated with the FQDN from the SSL VPN tunnel service.

12. The system of claim 11 wherein the SSL VPN service is further configured to receive a second request from the client after the configuration module disconnects the client from the SSL VPN tunnel service, and use at least one parameter from the configuration file to re-establish a SSL VPN tunnel service connection with the client.

13. The system of claim 10 wherein the FQDN module resolves the FQDN to the at least one IP address using a single threaded process that is separate from a main processing thread.

14. The system of claim 10 wherein the configuration file includes a plurality of resolved IP addresses so that the client can configure an SSL VPN tunnel route for each of the at least one resolved IP addresses.

15. The system of claim 10 wherein each FQDN has a time-to-live value, and the method further includes re-establishing a connection with the client using the client configuration file upon expiration of the time-to-live value.

16. The system of claim 10 wherein the FQDN is a public domain, a private domain, or a wildcard value.

17. The system of claim 10 further comprising a file system in user space to generate the configuration file dynamically in response to receiving the request from the client.

18. The system of claim 10 wherein the request includes at least one of a protocol used by the client and network allowed in the SSL VPN tunnel.

19. A computer program product for establishing a Secure Sockets Layer (SSL) Virtual Private Network (VPN) tunnel route, the computer program product comprising computer executable code embodied in one or more non-transitory computer readable media that, when executing on one or more processors, performs the steps of:
receiving a connection request from a client associated with a fully qualified domain name (FQDN) to use a SSL VPN tunnel service;
referencing a data storage for data associated with the client;
constructing a client configuration file based on the data associated with the client;
resolving the FQDN associated with the client to at least one internet protocol (IP) address;
storing the resolved IP address in the configuration file; and
communicating the configuration file to the client to instruct the client regarding how to configure an SSL VPN tunnel route for the at least one resolved IP address.

20. The computer program product of claim 19, wherein the computer program product further comprises computer executable code that, when executing on one or more processors, performs the steps of:
detecting a change in the resolution of the FQDN;
notifying a configuration service of the detected change in the FQDN resolution; and
disconnecting the client associated with the FQDN from the SSL VPN service.
